(19) United States
(12) Patent Application Publication
(10) Pub. No.: US 2014/0068006 A1
(43) Pub. Date: Mar. 6, 2014

(54) METHOD, APPARATUS AND SYSTEM FOR PROVIDING CONTENT

(71) Applicants: Sanjay SINGHAL, Burlington (CA); Gurminder KANDOLA, Burlington (CA); Waseem SAKKA, Burlington (CA); Jim HLAD, Burlington (CA)

(72) Inventors: Sanjay SINGHAL, Burlington (CA); Gurminder KANDOLA, Burlington (CA); Waseem SAKKA, Burlington (CA); Jim HLAD, Burlington (CA)

(73) Assignee: FUSENET INC., Burlington (CA)

(21) Appl. No.: 13/600,410

(22) Filed: Aug. 31, 2012

(51) Int. Cl. G06F 15/16

(52) U.S. Cl. 709/219

(57) ABSTRACT

A server and a method for providing content to client devices are provided. The server includes a network interface, a memory storage unit and a processor for carrying out the method. The method involves receiving a first request for the content, sending a first data chunk in response to the first request, receiving a marking data corresponding to a time-position of the content, receiving a second request for the content, and sending a second data chunk in response to the second request.

### FIELD

The present specification relates generally to providing content and more particularly to a providing content over a network.

### BACKGROUND

Traditionally, content is view on a device having a media reader. Content is written onto a physical medium readable by the media reader at a source. The physical medium is provided to the device and read by the media reader to generate output. More recently, content has been made available and provided over networks. Therefore, a device for generating content output no longer requires a locally present physical medium. Instead, content providers transfer data over a network from a server directly to a client device to generate output. With the increase in quality of both audio and video content, as well as improved digital rights management, the amount of data required to be transferred has increased, the demands on the network as well as servers and client devices have correspondingly increased. This ultimately leads to a decrease in the performance of systems for providing content over networks. However, the decreases in performance can be mitigated by outputting the content at the client device while simultaneously receiving data corresponding to the output (i.e. streaming). Indeed, there has been a rapid increase in the number and types of content available over networks. For example, musicians often provide samples of their works on websites in order to generate interest. As another example, television providers now routinely provide shows over the Internet as well.

### SUMMARY

In accordance with an aspect of the specification, there is provided a server for providing content. The server includes a network interface for receiving a first request for the content, receiving a second request for the content, and receiving a marking data file corresponding to a time-position of the content. The server further includes a memory storage unit for storing the content. In addition the server includes a processor in electrical communication with the network interface and the memory storage unit. The processor is configured to process the first request and to send a first data chunk representing a first portion of the content in response to the first request. Furthermore, the processor is configured to process the second request and to send a second data chunk representing a second portion of the content beginning at the time-position in response to the second request.

The content may be an audiobook.

The marking data file may include a content identifier associated with the content.

The marking data file may include a customer identifier associated with a customer account.

The second data chunk may be smaller than the first data chunk.

The first data chunk and the second data chunk may be files configured to be processed by a web browser of a client device.

The processor may be configured to send the first data chunk to a first client device. Furthermore, the processor may be configured to send the second data chunk to a second client device.

The network interface may be further configured to receive a second marking data file corresponding to a second time-position of the content.

The first marking data file may include a first timestamp and the second marking data file may include a second timestamp.

In accordance with an aspect of the specification, there is provided a method for providing content. The method involves receiving a first request for the content. The method further involves sending a first data chunk in response to the first request. The first data chunk represents a first portion of the content. Furthermore, the method involves receiving a marking data file corresponding to a time-position of the content. In addition, the method involves receiving a second request for the content. The method also involves sending a second data chunk in response to the second request. The second data chunk represents a second portion of the content, wherein the second portion of the content begins at the time-position.

The content may be an audiobook.

Receiving the marking data file may involve receiving a content identifier associated with the content.

Receiving the marking data file may involve receiving a customer identifier associated with a customer account.

The second data chunk may be smaller than the first data chunk.

Sending the first data chunk may involve sending a file to a web browser of a client device to be processed.

Sending the second data chunk may involve sending a file to a web browser of a client device to be processed.

Sending the first data chunk may involve sending the first data chunk to a first client device. In addition, ending the second data chunk may involve sending the second data chunk to a second client device.

The method may further involve receiving a second marking data file corresponding to a second time-position of the content. The second portion of the content may begin at one of the first time-position or the second time-position.

The first marking data file may include a first timestamp and the second marking data file may include a second timestamp.

In accordance with another aspect of the specification, a non-transitory computer readable medium encoded with codes. The codes direct a processor to receive, via a network interface, a first request for the content. The codes further direct the processor to send a first data chunk in response to the first request. The first data chunk representing a first portion of the content. Furthermore, the codes direct the processor to receive, via the network interface, a marking data file corresponding to a time-position of the content. In addition, the codes direct the processor to receive, via the network interface, a second request for the content. The codes also direct the processor to send a second data chunk in response to the second request. The second data chunk represents a second portion of the content, wherein the second portion of the content begins at the time-position.

### BRIEF DESCRIPTION OF THE DRAWINGS

Reference will now be made, by way of example, to the accompanying drawings in which:

FIG. 1 is a schematic representation of a system for providing content in accordance with an embodiment;

FIG. 2 is a schematic representation of a client device in accordance with the embodiment shown in FIG. 1;

FIG. 3 is a schematic representation of a server in accordance with the embodiment shown in FIG. 1;

FIG. 4 is a flow chart of a method for providing content in accordance with an embodiment;

FIG. 5 is a schematic representation of a system for providing content in accordance with another embodiment; and

FIG. 6 is a flow chart of a method for providing content in accordance with another embodiment.

### DETAILED DESCRIPTION OF THE EMBODIMENTS

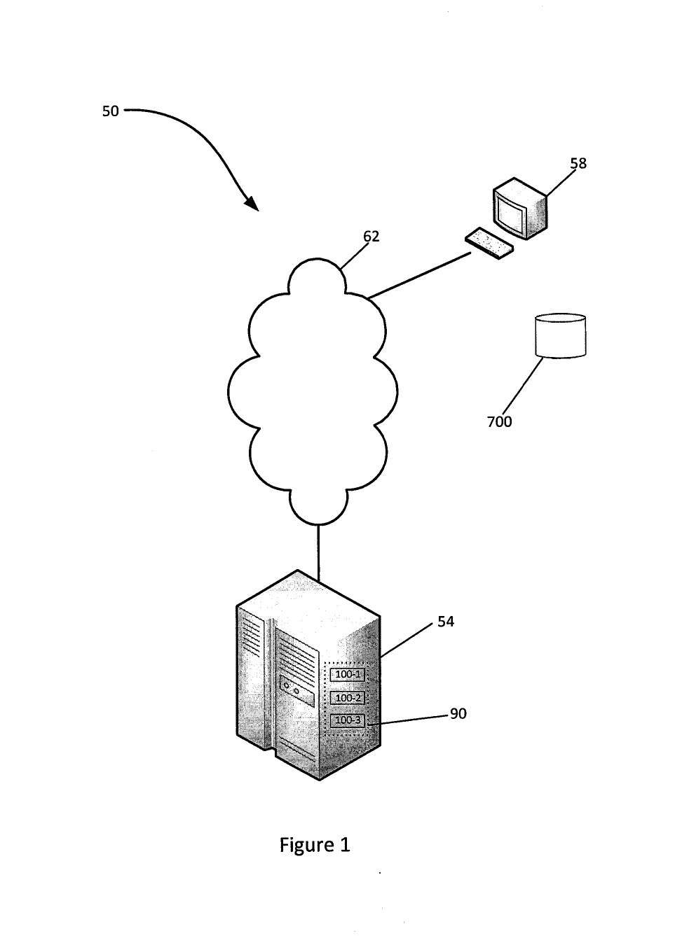

Referring to FIG. 1, a system for providing content is generally shown at 50. It is to be understood that the system 50 is purely exemplary and with the benefit of this specification, it will become apparent to those skilled in the art that a variety of systems are contemplated. The system 50 includes a server 54 and a client device 58 interconnected by a network 62.

In the present embodiment, the client device 58 can be any type of computing device used to communicate with the server 54 over the network 62 for receiving content. It is to be appreciated that, in general, the client device 58 includes programming instructions in the form of codes stored on a computer readable medium for performing the functions described in greater detail below. For example, the client device 58 can be any one of a personal computer, a laptop computer, a portable electronic device, a gaming device, a mobile computing device, a portable computing device, a tablet computing device, a personal digital assistant, a cell phone, a smart phone or the like. In the present embodiment, the client device 58 is configured to request content from the server 54 and to receive a data chunk from the server 54 over the network 62 in response to the request. The data chunk corresponds to at least a portion of the content. The content is not particularly limited and can be any type of content, such as media content. In addition, the data chunk can include metadata for indicating the length and size of the content. In the present embodiment, the content is an audiobook. Therefore, the data chunk can be an audio file encoded with digital audio output, such as a MP3, WAV, WMA, OGG, or M4B (M4A/MP4).

Furthermore, the client device 58 is generally configured to send a marking data in the form of file to the server 54. Although the present embodiment sends the marking data in a file, it is to be appreciated that the marking data can be sent in other formats. For example, the marking data can be a single data packet with a index number. The client device 58 is also configured to send a second request for content based on the marking data file, as discussed in greater detail below.

Although in the present embodiment, the content is described as an audiobook, it is re-emphasized that the above embodiment is a non-limiting example. In other embodiments, the content can include music, movies, or television shows. In further embodiments, the content can be text or still images. Furthermore, it is to be appreciated that generating the output of the content at the client device 58 is not particularly limited. For example, the present embodiment uses a web browser on the client device 58 to generate output at a speaker. In particular, the web browser is configured to process HTML5 (HyperText Markup Language, fifth version) instructions in the present embodiment. It is to be appreciated that HTML5 allows for the tracking of content being played to facilitate the generation of a marking data file, described below. In other embodiments, proprietary content player applications can be used to generate output associated with the content.

The network 62 is not particularly limited and can include any type of network such as the Internet, an intranet or a local area network, or a mobile network. In some embodiments, the network 62 can also be modified to include a peer to peer network.

In the present embodiment, the server 54 can be any type of computing device used to store and provide content over the network 62. For example, the server 54 can include high performance server systems such as HP Blade servers having a plurality of ProLiant server blades. Another example of a server is the Sun Fire V480 (Sun Microsystems, Inc.) running a UNIX operating system, and having four central processing units each operating at about 900 megahertz and having about four gigabytes of random access memory and a non-volatile storage device such as a hard disc drive. Alternatively, the server 54 can include a desktop personal computer configured to carry out similar functions for systems not requiring a server with significant processing power, such as when content is provided to a relatively small number of client devices 58. In other embodiments, the server 54 can be implemented as one or more virtual servers, or a rented server session in the cloud accessed through the network 62.

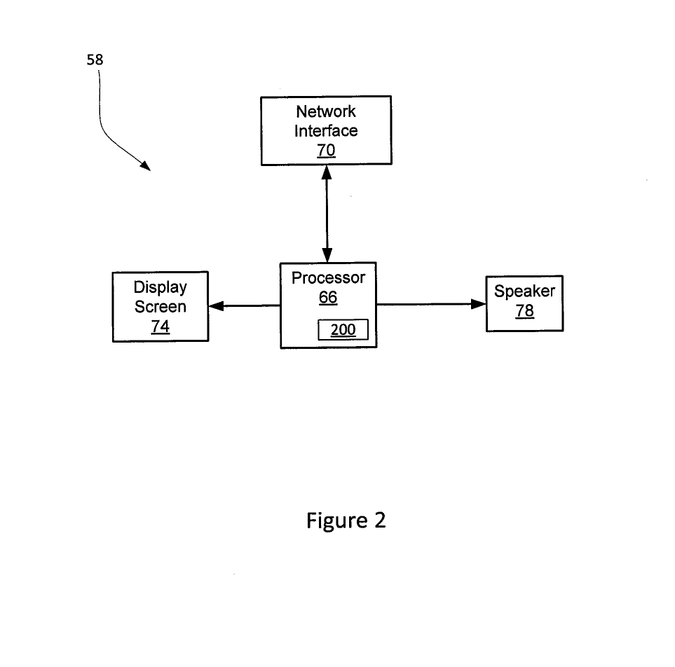

Referring to FIG. 2, a schematic block diagram of the electronic components of the client device 58 is shown. It should be emphasized that the structure in FIG. 2 is purely exemplary. In the present embodiment, the client device 58 is configured to generate output corresponding to the content of a data chunk received from the server 54. The client device 58 includes a processor 66, a network interface 70, a display screen 74 and a speaker 78. The network interface 70, the display screen 74 and the speaker 78 are each in electrical communication with the processor 66.

The display screen 74 is not particularly limited and can include a variety of different types of screens such as an array of light emitting diodes (LED), liquid crystals, plasma cells, organic light emitting diodes (OLED), or an electrophoretic ink (E ink) screen. Furthermore, the display screen 74 can be a touchscreen configured to receive input for controlling the client device 58.

The speaker 78 is also not particularly limited and can be of any type of speaker. For example, the client device 58 can include a built in speaker commonly found in portable computing devices. In other examples, the client device 58 can include an external speaker capable of generating louder audio output when desired. Furthermore, the client device 58 can be configured to provide monophonic sound, stereophonic sound such as surround sound, or virtual surround sound. In addition, the speaker 78 can also be linked to other speakers (not shown) through a wireless connection, such as Bluetooth or WI-FI, for applications where wireless connections are desirable such as in a car audio system.

The network interface 70 is not particularly limited and can include various network interface devices such as a network interface controller (NIC). The network interface 70 is generally configured to connect the client device 58 to the network 62. For example, the network interface 70 can connect to the network 62 using a data link layer standard such as Ethernet, Wi-Fi, mobile network (such as, but not limited to, fourth generation (4G), third generation (3G), code division multiple access (CDMA), Groupe Spécial Mobile (GSM) or Long Term Evolution (LTE) standards), or Token Ring.

The processor 66 is generally configured to execute programming instructions 200 for receiving data via the network interface 70, such as the data chunk from the server 54. In general, the programming instructions 200 are stored in a computer readable storage medium accessible by the processor 66. A request for content is generated by the processor 66 which causes the network interface 70 to send the request via the network 62 to the server 54. The request is not particularly limited and can include various identifiers. For example, the request can include a content identifier or a customer identifier. It is to be appreciated that in embodiments where a selection of various content is available, the content identifier allows the client device 58 to request specific content to be received. Alternatively, in embodiments where the consumer of the content is to be identified, such as for the purpose of collecting a fee from the consumer, the customer identifier can be used to identify the consumer. For example, the content identifier can include an International Standard Book Number, Title, or other means of identifying content such as an audiobook. The customer identifier can include a data record having fields including a username and a password. The fields of the customer identifier can be populated automatically by the client device 58 or using an input device (not shown) of the client device. In other embodiments where the client device 58 is configured to generate output for specific content determined at the server 54, the request can be used to indicate that the client device 58 is ready to receive the data chunk without the need for the content identifier or the customer identifier. The manner in which a request for content is sent is not particularly limited. In the present embodiment, the request is sent upon receiving input at the processor 66 from an input device. For example, the user can be sent a URL directed to an audiobook on the server 54 which will initiate a download. In other embodiments, the request can be automatically sent when the client device 58 is powered on. In further embodiments, the request can be automatically sent when an application, such as a proprietary application for receiving content, is started.

The programming instructions 200 further configure the processor 66 to process the data chunk from the server 54 to render output of the display screen 74, the speaker 78, or both. In the present embodiment, the data chunk is a file configured to be processed by programming instructions 200 of a web browser or native mobile application running on the client device 58. However, in other embodiments, the data chunk can be a proprietary format configured to be processed by programming instructions 200 of a application running on the client device 58. In the present embodiment, the programming instructions 200 also configure the processor 66 to receive the data chunk while simultaneously rendering portions of the data chunk which have been received in order to stream the content. Therefore, it is to be appreciated that for large data chunks, the client device 58 can begin rendering output without having to wait for the entire transfer of the data chunk to be completed.

Furthermore, the programming instructions 200 configure the processor 66 to generate a marking data file including a time-position of content. The marking data file is generally configured to mark the time-position of the content for fast reference. The marking data file for content, such as an audiobook, is sent via the network interface 70 to the network 62 and ultimately to the server 54. In general, content provided to the client device 58 is configured to cause the processor 66 to render output on the display screen 74 or the speaker 78 over a pre-determined length of time. For example, an audiobook is typically about 3 to about 5 hours; however, some audiobooks can be as short as a few minutes or as long as several days. In the present embodiment, the time-position represents the portion of the content occurring at a time measured from the beginning of the audiobook. In other embodiments involving other types of content, the time-position can represent an indexed portion of the content.

The marking data file is not particularly limited and can include various identifiers. For example, the marking data file can include a content identifier or a customer identifier. It is to be appreciated that in embodiments where the client device 58 is configured to receive multiple content, such as multiple audiobooks or a combination of audiobook and video content, the content identifier identifies the content, such as an audiobook with which the marking data file is associated and the customer identifier allows for tracking the provider of the marking data file. For example, the content identifier can include an International Standard Book Number, Title, or other means of identifying content, such as an audiobook. The customer identifier can include a data record having fields including a username and a password. The fields of the customer identifier can be populated automatically by the client device 58 or using an input device (not shown) of the client device at the time of generation. It is to be appreciated that the content identifier and the customer identifier are optional for embodiments where the client device 58 is associated with a single customer account and capable of receiving a single piece of content, such as one audiobook, at a time.

The manner in which the marking data file is generated and sent is not particularly limited and can involve various triggers. For example, the processor 66 can generate and send the marking data file upon receiving input from an input device. Alternatively, the processor 66 can automatically generate and send the marking data file when the application processing the data chunk is closed on the client device 58. It is to be appreciated that sending the marking data file at the closing of an application would allow the client device 58 to mark the time-position of where the client device 58 stopped rendering output. In another example, the processor 66 can automatically generate and send marking data files periodically after a pre-determined period of time. It is to be appreciated that this would allow the client device 58 to mark the approximate time-position of the content that is being rendered. Furthermore, it is also to be appreciated, with the benefit of the above description, that by periodically generating marking data files and sending the marking data files to the server 54, the marking data files will still be sent to the server 54 relatively recently in the event of a failure of the client device 58 preventing the application processing the data chunk from closing properly. Some examples of these types of failures include a software crash, unexpected loss of power, network unavailability and physical damage to the device. It is to be appreciated that with a shorter time period between the generation of the marking data files results in a generally more accurate time-position in the event of a failure. However, with a shorter time period, the resources used by the client device 58 increases.

In the present embodiment, the client device 58 is generally connected to network 62. However, it is to be appreciated with the benefit of this specification, that the client device 58 can be temporarily disconnected from the network 62. When the client device 58 is temporarily disconnected from the network 62, the processor 66 stores any generated marking data file in a queue until the client device 58 is reconnected with the network. Once the processor 66 determines that the network interface has reconnected to the network 62, the processor 66 sends the marking data files to the server 54. The manner in which the marking data files are stored by the processor 66 is not particularly limited. However, it is to be appreciated that different marking data files generated by the processor 66 at different times during the temporary disconnection should be distinguishable. For example, the marking data files can be stored in a queue where the first marking data file stored will be the first marking data file sent to the server 54 once the connection has been restored. In other embodiments, the marking data files can include a time stamp such that the marking data files can be sorted at a later time by the server 54. Although, the embodiment of the client device 58 is generally connected to the network 62, it is to be appreciated that the client device 58 can be modified such at that the client device 58 is generally not connected to the Internet. In such embodiments, the marking data files would generally be queued for later upload to the server 54 or time stamped so that the server 54 can sort the marking data files in chronological order.

In general terms, the client device 58 is generally configured to receive content and render output associated with the content. However, it is to be re-emphasized that the structure shown in FIG. 2 is a schematic, non-limiting representation. For example, although the present embodiment shown in FIG. 2 includes both a screen and a speaker, it is to be appreciated that for embodiments where the client device 58 is intended to generate audio output or video output, the client device can be modified to include a speaker or display screen, respectively. Furthermore, in some embodiments, the client device 58 can be modified to include output connections for external output devices such as an amplifier or a projector such that the client device 58 does not include either a speaker or a screen, respectively. Therefore, it is to be appreciated that the client device 58 can be modified to include fewer components to reduce costs as well as the amount of manufacturing resources used.

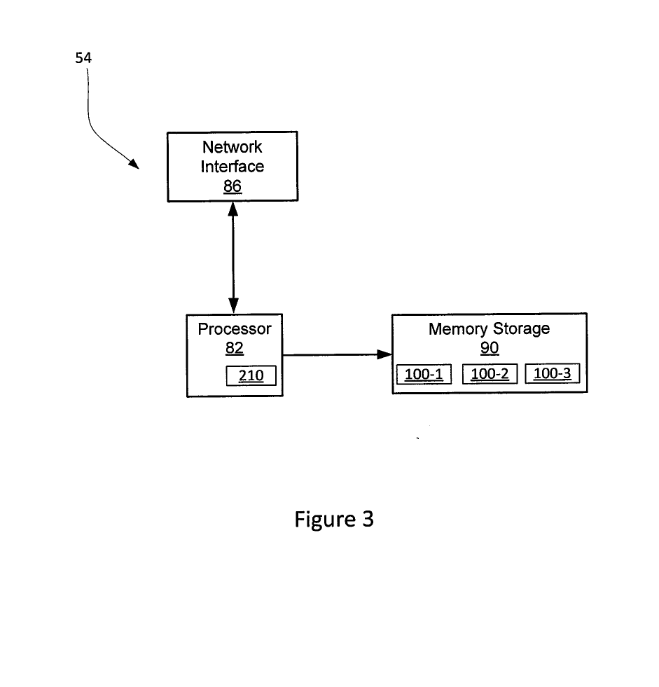

Referring to FIG. 3, a schematic block diagram of the electronic components of the server 54 is shown. It should be emphasized that the structure in FIG. 3 is purely exemplary and several different implementations and configurations for server 54 are contemplated. In the present embodiment, the server 54 is configured to provide content to the client device 58 via the network 62. The server 54 includes a processor 82, a network interface 86, and a memory storage unit 90. The network interface 86 and the memory storage unit 90 are each in electrical communication with the processor 82.

The network interface 86 is not particularly limited and can include various network interface devices such as a network interface controller (NIC) similar to the network interface 70 described above. In particular, the network interface 86 is generally configured to connect the network 62. For example, the network interface 82 can connect to the network 62 using a data link layer standard such as Ethernet, Wi-Fi, mobile network (such as, but not limited to, fourth generation (4G), third generation (3G), code division multiple access (CDMA), Groupe Special Mobile (GSM) or Long Term Evolution (LTE) standards), or Token Ring.

The memory storage unit 90 can be of any type such as non-volatile memory (e.g. Electrically Erasable Programmable Read Only Memory (EEPROM), Flash Memory, hard disk, floppy disk, optical disk, solid state drive, or tape drive) or volatile memory (e.g. random access memory (RAM)). Although the memory storage unit 90 is generally a type of non-volatile memory because of the robust nature of non-volatile memory, some embodiments can use volatile memory in situations where high access speed is desired. In the present embodiment, the memory storage unit 90 is a non-volatile memory unit storing a plurality of audiobooks 100-1, 100-2, and 100-3.

The processor 82 is generally configured to execute programming instructions 210 for receiving requests from the network interface 86, such as a request for content from the client device 58. In the present embodiment, the request received by the processor 82 can include various identifiers. For example, the request can include a content identifier or a customer identifier. The content identifier can include an International Standard Book Number, Title, or other means of identifying content such as one of the audiobooks 100-1, 100-2, or 100-3. The customer identifier can include a data record having fields including a username and a password to identify a customer account 700. It is to be appreciated that in embodiments where content is subject to digital rights management (DRM) restrictions or otherwise not freely available to everyone, such as content having a licensing fee, the customer identifier allows the server 54 to determine if the customer account 700 associated with the customer identifier includes a flag or other electronic indicator authorizing reception of the requested content. In other embodiments where the server 54 is configured to provide a single content to a client device 58, the request does not need to include the content identifier or the customer identifier.

The programming instructions 210 further cause the processor 82 to generate a data chunk for sending to the client device 58 based on the request. In the present embodiment, the data chunk is a file configured to include data representing at least a portion of one of the audiobooks 100-1, 100-2, and 100-3 to be processed by the client device 58. Therefore, if the content identifier identifies the audiobook 100-1, the processor 82 will generate a data chunk which includes at least a portion of the audiobook 100-1 in a format readable by the client device 58. The data chunk is not particularly limited and can include data in a standard format for processing by a web browser or a native mobile application on the client device 58 such as a a MP3, WAV, WMA, OGG, or M4B (M4A/MP4 compatible) file. However, in other embodiments, the data chunk can include data having a proprietary format configured to be processed using a proprietary application on the client device 58.

The programming instructions 210 further configure the processor 82 to send the data chunk to the client device 58 based on the request for content. The processor 82 sends the data chunk to the network interface 86 for sending via the network 62 to the client device 58.

Furthermore, the programming instructions 210 configure the processor 82 to receive a marking data file having data corresponding to a time-position of content. The marking data file for content, such as the audiobook 100-1, 100-2, or 100-3, is received at the network interface 86 via the network 62 from the client device 58. The processor 82 is configured to store the marking data file on the server 54. For example, the marking data file can be stored in the memory storage unit 90 in the present embodiment. In other embodiments, the marking data file can be stored in a separate memory storage unit (not shown). The marking data file is not particularly limited and can also include various identifiers. For example, the marking data file can include a content identifier or a customer identifier. It is to be appreciated that in embodiments where the server is configured to send multiple content such as audiobooks 100-1, 100-2, and 100-3, the content identifier can identify the audiobook with which the marking data file is associated and the customer identifier provides a means for tracking the source of the marking data file. For example, the content identifier can include an International Standard Book Number, Title, or other means of identifying the audiobook 100-1. The customer identifier can include a data record having fields including a username and a password to identify the customer account 700. It is to be appreciated that the content identifier and the customer identifier are optional for embodiments such as ones where a server is associated with a single customer account 700 and capable of sending one piece of content, such as a single audiobook. However, in embodiments such as the present embodiment where the server 54 provides more content such as a plurality of audiobooks, the marking data file generally includes at least an identifier, such as the content identifier or a customer identifier.

Upon receipt of a second request from the client device 58, the programming instructions 210 further cause the processor 82 to generate a second data chunk for sending to the client device 58 based on the marking data file. In the present example, the marking data file is associated with the audiobook 100-1 and the second data chunk represents a second portion of the content beginning at the time-position associated with the marking data file. In particular, the second data chunk is a file configured to include data representing a portion of the audiobook 100-1 beginning at the time-position to be sent over the network 62 to the client device 58.

In general terms, the server 54 is generally configured provide content to the client device. However, it is to be re-emphasized that the structure shown in FIG. 3 is a schematic, non-limiting representation. For example, although the present embodiment shown in FIG. 3 includes the memory storage unit 90 for storing the three audiobooks 100-1, 100-2, and 100-3, it is to be understood that the memory storage unit 90 can be modified to store more or less audiobooks. Furthermore, it is to be understood, with the benefit of this description, that audiobooks are but one type of content and that other types of content as well as a combination of several types of content are contemplated.

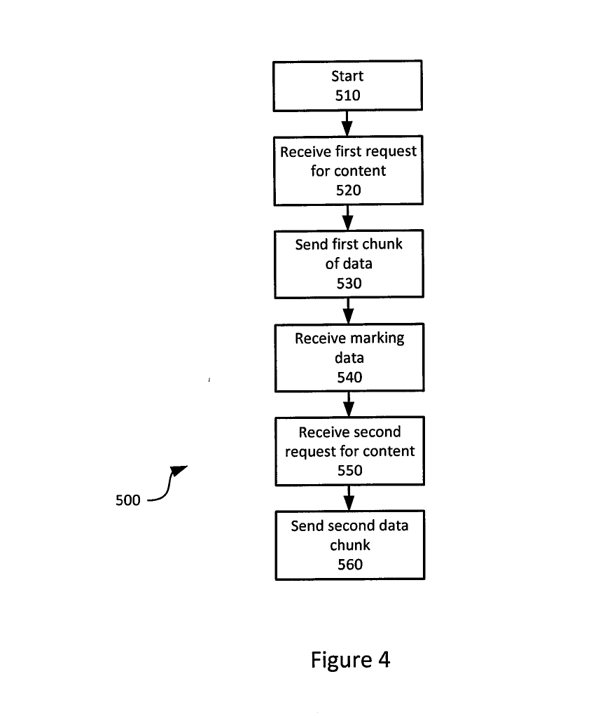

Referring now to FIG. 4, a method for providing content to the client device 58 is represented in the form of a flow-chart and indicated generally at 500. In order to assist in the explanation of the method 500, it will be assumed that the method 500 is performed using the system 50. Furthermore, the following discussion of the method 500 will lead to further understanding of the system 50 and its various components. However, it is to be understood that the system 50 and/or the method 500 can be varied, and need not work exactly as discussed herein in conjunction with each other, and that such variations are within the scope of the present invention. Furthermore, it is to be emphasized, that method 500 need not be performed in the exact sequence as shown and that various blocks can be performed in parallel rather than in sequence; hence the elements of the method 500 are referred to herein as “blocks” rather than “steps”.

Block 510 is the start of the method 500. The manner in which the method 500 is started is not particularly limited. For example, the method 500 can start upon receiving input at the client device 58. Alternatively, the method 500 can start when the client device 58 is powered on or connected to the network 62. In another embodiment, the method 500 can also start when an application, such as a web browser, is executed.

Block 520 comprises the server 54 receiving a request for content from the client device 58. The request is not particularly limited and can include various identifiers, such as a content identifier or a customer identifier. Furthermore, the manner in which a request for content is sent is not particularly limited. In the present embodiment, the request is a data file generated by the processor 66 of the client device 58 upon the start of the method 500. The processor 66 instructs the network interface 70 to send the request via the network 62 to the server 54. At the server 54, the request is received by the network interface 86. For example, the request can include a content identifier for the audiobook 100-1 (shown in FIG. 3) and a customer identifier associated with the customer account 700 (shown in FIG. 1).

Block 530 comprises the server 54 sending a data chunk to the client device 58. The manner in which the data chunk is sent is not particularly limited and can include similar methods as those discussed above. It is to be appreciated, with the benefit of this description, that the manner by which the data chunk is sent in the present embodiment follows the same path as that described above in Block 520 except in the opposite direction. In other embodiments, the data chunk can be sent using a different path involving different hardware components of the system. In particular, it will now be understood, after the description of the request and the data chunk, that the request is generally a small data message or file whereas the data chunk is a larger file that includes data associated with the content. Therefore, since more data is transferred for the data chunk, some embodiments can involve using different paths for the transfer of the request and the data chunk to increase the performance of the system 50 by more efficiently using the resources of the system.

Block 540 comprises the server 54 receiving a marking data file from the client device 58. The marking data file is not particularly limited and can include various identifiers, such as a content identifier or a customer identifier. Furthermore, the manner in which the marking data file is sent is not particularly limited. In the present embodiment, the marking data file is generated by the processor 66 of the client device 58 as a result of various triggers discussed above. Furthermore, the marking data file in the present example can include a content identifier for the audiobook 100-1 (shown in FIG. 3) and a customer identifier associated with the customer account 700 (shown in FIG. 1). The manner in which the marking data file is sent is not particularly limited and can include similar methods as those discussed above in connection with sending the request in Block 520. In other embodiments, the marking data file can be sent using a different path involving different hardware components of the system 50.

In the present embodiment, a single marking data file is sent in Block 540. However, it is to be re-emphasized that the method 500 is a non-limiting representation and several variations are contemplated. For example, if the trigger for generating the marking data file at the client device 58 involves the expiration of a period of time, such as for an auto-save feature, more than one marking data file can be sent to the server 54. Each of the marking data files sent to the server 54 would include a time-position of the content associated with the trigger event, such as the expiration of a period of time. In addition, each marking data file can also include an optional timestamp corresponding the time when the marking data file is generated. It is to be appreciated that the timestamp can be used by the server 54 to determine the most recent marking data file and to arrange the marking data files in chronological order. Alternatively, the server 54 can store the marking data files in a queue to maintain the order in which each marking data file is received. In further embodiments, the server 54 can be configured to store only the most recent marking data file received by overwriting previously received marking data files.

Block 550 comprises the server 54 receiving a second request for content from the client device 58. The request is not particularly limited and can include various identifiers, such as a content identifier or a customer identifier. In the present embodiment, the second request is in the same format as the request of Block 520. Furthermore, the manner in which the second request for content is sent is not particularly limited and can include the methods discussed above in Block 520. Furthermore, the second request can also include a content identifier for the audiobook 100-1 (shown in FIG. 3) and a customer identifier associated with the customer account 700 (shown in FIG. 1).

Although the present embodiment of the method 500 shows the second request for content of Block 550 is similar to the original request for content of Block 520, variants are possible. For example, a variant of the method 500 can include the client device 58 generating a second request which includes a marking data file identifier. It is to be appreciated that in some embodiments, the client device 58 can generate a plurality of marking data files for sending to the server 54. In such embodiments, the client device 58 can optionally maintain a log of the marking data files sent to the server 54. When generating the second request, the client device 58 can select a marking data file from the log to be associated with the second request. It is to be appreciated that in some variants, a marking data file identifier, such as a timestamp, an identification number, or other unique identification string, can be used to associate the marking data file with the second request. Alternatively, the complete marking data file can be re-sent to the sever 54 along with the second request for content. It is to be appreciated, with the benefit of this description, that in some variants, Block 540 and Block 550 can be combined such that the marking data file and the second request for content are sent simultaneously.

Block 560 comprises the server 54 sending a second data chunk to the client device 58 based on a time-position of a marking data file. The manner in which the second data chunk is sent is not particularly limited and can include similar methods as those discussed above in connection with sending the first data chunk of Block 530. It in the present embodiment, the second data chunk is the same type of files as the first data chunk described in connection with Block 530. In accordance with the present example, the second data chunk corresponds to at least a portion of the content (i.e. audiobook 100-1), where the second data chunk corresponds to a portion of the content beginning at the time-position stored in the associated marking data file.

In the present embodiment, the portion of the content that is sent in a data chunk from the server 54 to the client device 58 generally includes the portion of the content from where the client device 58 is to generate content to the end of the content. Therefore, it is to be appreciated that since the second data chunk corresponds to a portion of the content beginning at a time-position of the marking data file, the second data chunk is generally smaller in size than the first data chunk. However, in other embodiments, the size of the data chunk can be limited by the web browser or application or other resources on the client device 58. Therefore, the size of the data chunks can also be identical. In further embodiments, it is to be appreciated that second data chunk can be larger than the first data chunk. For example, additional content can be added between the first and second requests, the marking data file includes a time-position prior to the beginning of the first data chunk, or the second data chunk can be chosen to be of a different format, such as one with higher quality output. Therefore, it is to be appreciated that the size of the chunks are dependent on the client device 58 and the web browser or application.

In the present embodiment, the server 54 uses the most recently received marking data file corresponding to the content identifier and the customer identifier. However, it is to be re-emphasized that Block 560 is a non-limiting representation and several variations are contemplated. For example, a variant can include an additional step of the server 54 requesting input from the client device 58 associated with selecting a marking data file from a plurality of marking data files stored on the server. In such embodiments, the server 54 can send data corresponding to the plurality of marking data files to the client device 58 for display in a menu. For aiding in the selection of the marking data file, the server 54 can optionally store a nickname associated with each marking data file. It is to be appreciated that by allowing the client device 58 to select from a variety of marking data files, it is advantageous for applications where the client device 58 may not output the content in a chronological order or for applications where the client device 58 is requested to re-generate output of certain portions of the content on a frequent basis. One such application can be for reference content, such as an audiobook, which is used as a research reference.

Again, it is to be re-emphasized that the method 500 described above is a non-limiting representation. For example, the variants discussed above can be combined with other variants. Furthermore, it is to be understood that the method 500 can be configured to loop optionally back to the start at Block 510 to mark the time-position of the content so that the client device 58 can continue generating output from that location.

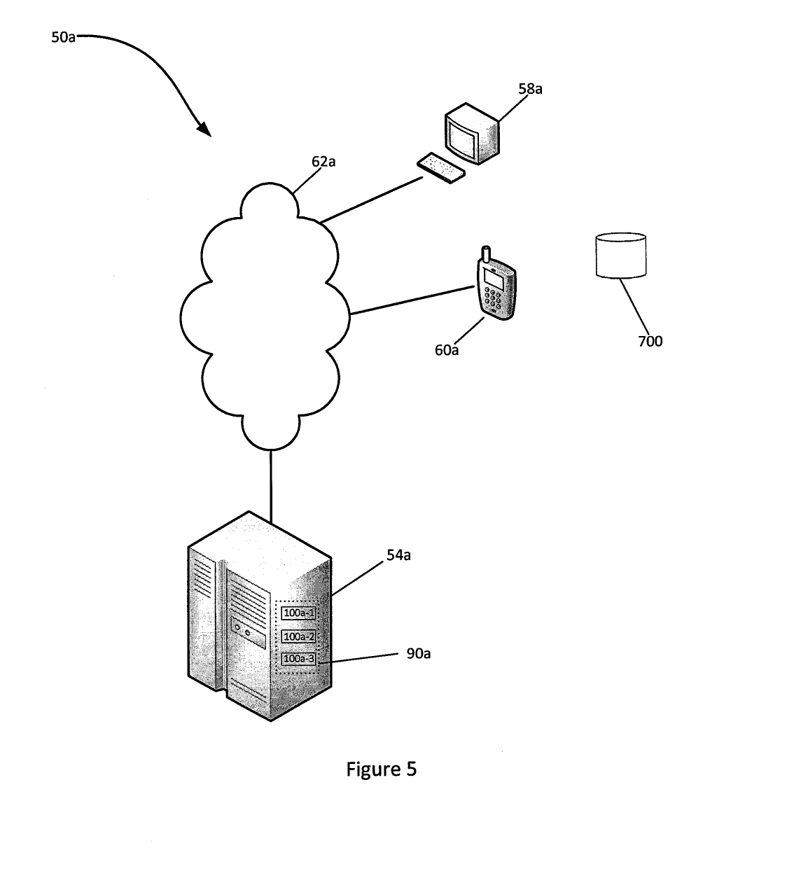

Referring to FIG. 5, another embodiment of a system for providing content is generally shown at 50a. Like components of the system 50a bear like reference to their counterparts in the 50, except followed by the suffix “a”. Similar to the system 50, the system 50a includes a server 54a and a client device 58a interconnected by a network 62a which have similar characteristics as the server 54, the client device 58 and the network 62, respectively. In addition, the system 50a further includes a second client device 60a. In the present embodiment, the server 54a also includes a memory storage unit 90a for storing content, such as audiobooks 100a-1, 100a-2, and 100a-3.

In the present embodiment, the client device 60a can be any type of computing device used to communicate with the server 54a over the network 62a for receiving content including the types of devices discussed above in connection with the client device 58. It is to be appreciated that the client device 58a and the client device 60a can be the same type of device or different types of devices. In the present embodiment, both of the client device 58a and the client device 60a are associated with the customer account 700. For example, the client device 58a can be a desktop computer and the client device 60a can be a smartphone or portable electronic device. In this example, the client device 58a can be used to generate output using higher quality output devices such as better speakers or a better display screen. However, in the client device 60a can be used when increased portability is desired such as when traveling. Although the present embodiment shows that the client device 58a and the client device 60a are associated with the same customer account 700, in other embodiments, the client device 58a and the client device 60a can be associated with different customer accounts. For example, each of the client devices 58a and 60a can be associated with more than one customer account, such as in the situation of a shared workstation.

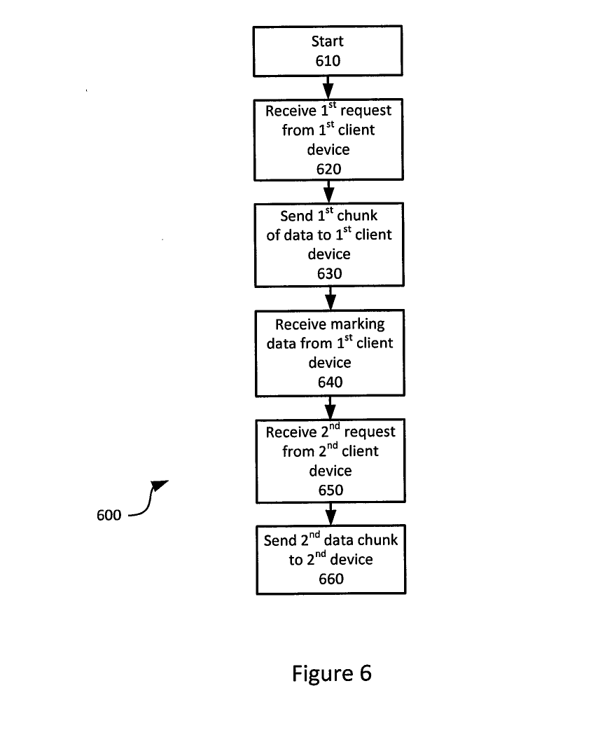

Referring to FIG. 6, a method for providing content to the client device 58a and the client device 60a is represented in the form of a flow-chart and indicated generally at 600. In order to assist in the explanation of the method 600, it will be assumed that the method 600 is performed using the system 50a. Furthermore, the following discussion of the method 600 will lead to further understanding of the system 50a and its various components. However, it is to be understood that the system 50a and/or the method 600 can be varied, and need not work exactly as discussed herein in conjunction with each other, and that such variations are within the scope of the present invention. Furthermore, it is to be emphasized, that method 600 need not be performed in the exact sequence as shown and that various blocks can be performed in parallel rather than in sequence; hence the elements of the method 600 are referred to herein as “blocks” rather than “steps”.

Block 610 is the start of the method 600. The manner in which the method 600 is started is not particularly limited. For example, the method 600 can start upon receiving input at the client device 58a. Alternatively, the method 600 can start when the client device 58a is powered on. In another embodiment, the method 600 can also begin when an application, such as a web browser, is executed.

Block 620 comprises the server 54a receiving a request for content from the client device 58a. The manner in which the request is received is not particularly limited and includes methods similar to those described above in Block 520.

Block 630 comprises the server 54a sending a data chunk to the client device 58a. The manner in which the data chunk is sent is not particularly limited and can include similar methods as those described above in Block 530.

Next, Block 640 comprises the server 54a receiving a marking data file from the client device 58a. The manner in which the data chunk is sent is not particularly limited and can include similar methods as those described above in Block 540.

Block 650 comprises the server 54a receiving a second request for content from the client device 60a. The request is not particularly limited and can include various identifiers, such as a content identifier or a customer identifier. The manner in which the second request for content is sent is not particularly limited and can include the methods discussed above in Block 620 except substituting the client device 60a instead of the client device 58a. For example, the second request can include a content identifier for the audiobook 100a-1 and a customer identifier associated with the customer account 700.

In the present embodiment, the second request is in the same format as the request of Block 620 from the client device 58a. However, in other embodiments, the second request can be of a different format since the client device 60a can be of a different type than the client device 58a.

Other variants can include the client device 58a generating a second request which includes a marking data file identifier. It is to be appreciated that in some embodiments, the client device 58a can generate a plurality of marking data files for sending to the server 54a. In such embodiments, the server 54a can optionally maintain a log of the marking data files received from the client device 58a. When generating the second request, the client device 60a can select a marking data file from the list of the marking data files provided to the client device 60a by the server 54a. A marking data file identifier, such as a timestamp, an identification number, or other unique identification string, can be used to identify the marking data file associated with the second request.

Block 660 comprises the server 54a sending a second data chunk based on a time-position of a marking data file to the client device 60a. The manner in which the second data chunk is sent is not particularly limited and can include similar methods as those discussed above in connection with sending the first data chunk of Block 630 if the client device 60a is capable of receiving the second data chunk with those methods. Alternatively, it is to be appreciated that the client device 60a can use another method for receiving the second data chunk. For example, if the client device 58a is a desktop computer, the client device 58a can be connected using a wire to the network 62a. If the client device 60a is a smartphone, the client device 60a can be connected to the network using a wireless connection instead. In accordance with the present example, the second data chunk corresponds to at least a portion of the content (i.e. audiobook 100a-1), where the second data chunk corresponds to a portion of the content beginning at the time-position stored in the associate marking data file.

In the present embodiment, it is to be appreciated that the method 600 allows a client device 58a to start generating output associated with content for the customer account 700. If the generation of output at the client device 58a is interrupted either intentionally or unintentionally, the client device 60a can continue to generate output from the approximate point of the content where the interruption occurred using the time-position of the marking data file to indicate where the client device 58a was interrupted. This feature provides the content to two devices such that the output can be viewed on either device.

Again, it is to be re-emphasized that the method 600 described above is a non-limiting representation. For example, although only two client devices were described above, it is to be appreciated, with the benefit of this description, that any number of client devices can be included in the system 50a such that any one of the client devices can be selected to receive the second data chunk.

It is to be understood that variations of the systems 50 and 50a described above are contemplated. As a non-limiting example, it is to be appreciated that the client device 58a and the client device 60a can be interchanged in the method 600 such that the content is initially generated on the more portable client device 60a and continued on the client device 58a. Furthermore, it is to be appreciated that method 600 can be repeated such that the customer account 700 can switch between the client device 58a and the client device 60a multiple times.

As another non-limiting example, it is to be appreciated that the method 500 described above can be carried out on the system 50a.

As another non-limiting example, additional servers can be added to the system 50 such that each server can store different content, or represent a different vendor. Alternatively, the same content can be stored on several servers to increase the capability of the system 50 to handle more client devices associated with multiple customer accounts where several client devices can request the same content. In another embodiment having multiple servers, each server can be configured to store a portion of the content such that client devices can request portions of the content from different servers to improve efficient use of the network resources.

As another non-limiting example, the systems 50 and 50a can include programming instructions to control the access to content. For example, access control can be part of a digital rights management program where the content is protected, for example, by copyright holders. The access control can be part the programming instructions on the client devices, the server, or both. For example, the server can include a database having a list of content (identified with the content identifier of each request and marking data file) associated with each customer account (identified with the customer identifier of each request and marking data file). Therefore, every request received by the server can be checked against the database to ensure that the customer account has rights to the content requested before sending data chunks. Furthermore, each client device can include programming instructions to delete the data chunks once the web browser or other application processing the data chunk is closed to ensure that extra copies do not remain on a client device for a future unauthorized viewing.

Various advantages will now be apparent. Of note is the ability to provide content to a client device and continue providing content after an interruption using the marking data file. By sending a second data chunk file beginning at a specified time-position, the client device can begin receiving the second data chunk and generating output in a more efficient manner. As discussed above, the second data chunk file is generally smaller than the first data chunk file. Therefore, it is to be appreciated than another advantage is that network resources are more efficiently used since less data is transferred across the network. In addition, resources directed to digital rights management will also be reduced as less data needs to be managed. Furthermore, attempts to defeat other digital rights management restrictions are hampered because the entire copy of the content can be spread across a number of devices, making it difficult to assemble a complete copy of the protected content.

While specific embodiments have been described and illustrated, such embodiments should be considered illustrative and should not serve to limit the accompanying claims.

What is claimed is:

1. A server for providing content, the server comprising:
a network interface for receiving a first request for the content, receiving a second request for the content, and receiving a marking data corresponding to a time-position of the content;
a memory storage unit for storing the content; and
a processor in electrical communication with the network interface and the memory storage unit, the processor configured to process the first request and to send a first data chunk representing a first portion of the content in response to the first request, and the processor configured to process the second request and to send a second data chunk representing a second portion of the content beginning at the time-position in response to the second request.

2. The server of claim 1, wherein the content is an audiobook.

3. The server of claim 1, wherein the marking data comprises a content identifier associated with the content.

4. The server of claim 1, wherein the marking data comprises a customer identifier associated with a customer account.

5. The server of claim 1, wherein the second data chunk is smaller than the first data chunk.

6. The server of claim 1, wherein the first data chunk and the second data chunk are files configured to be processed by a web browser of a client device.

7. The server of claim 1, wherein the processor is configured to send the first data chunk to a first client device, and wherein the processor is configured to send the second data chunk to a second client device.

8. The server of claim 1, wherein the network interface is further configured to receive a second marking data corresponding to a second time-position of the content.

9. The server of claim 8, wherein the first marking data comprises a first timestamp and the second marking data comprises a second timestamp.

10. A method for providing content, the method comprising:
receiving a first request for the content;
sending a first data chunk in response to the first request, the first data chunk representing a first portion of the content;
receiving a marking data corresponding to a time-position of the content;
receiving a second request for the content; and
sending a second data chunk in response to the second request, the second data chunk representing a second portion of the content, wherein the second portion of the content begins at the time-position.

11. The method of claim 10, wherein the content is an audiobook.

12. The method of claim 10, wherein receiving the marking data comprises receiving a content identifier associated with the content.

13. The method of claim 10, wherein receiving the marking data comprises receiving a customer identifier associated with a customer account.

14. The method of claim 10, wherein the second data chunk is smaller than the first data chunk.

15. The method of claim 10, wherein sending the first data chunk comprises sending a file to a web browser of a client device to be processed.

16. The method of claim 10, wherein sending the second data chunk comprises sending a file to a web browser of a client device to be processed.

17. The method of claim 10, wherein sending the first data chunk comprises sending the first data chunk to a first client device, and wherein sending the second data chunk comprises sending the second data chunk to a second client device.

18. The method of claim 10, further comprising receiving a second marking data corresponding to a second time-position of the content, and wherein the second portion of the content begins at one of the first time-position or the second time-position.

19. The method of claim 18, wherein the first marking data comprises a first timestamp and the second marking data comprises a second timestamp.

20. A non-transitory computer readable medium encoded with codes, the codes for directing a processor to:
receive, via a network interface, a first request for the content;
send a first data chunk in response to the first request, the first data chunk representing a first portion of the content;
receive, via the network interface, a marking data corresponding to a time-position of the content;
receive, via the network interface, a second request for the content; and
send a second data chunk in response to the second request, the second data chunk representing a second portion of the content, wherein the second portion of the content begins at the time-position.
